(19) United States
(12) Patent Application Publication
(10) Pub. No.: US 2006/0232582 A1
(43) Pub. Date: Oct. 19, 2006

(54) VIRTUAL REALITY THEATER

(76) Inventor: Matthew J. Fannon, Henderson, NV (US)

Correspondence Address: GREENBERG & LIEBERMAN, LLC, 2141 WISCONSIN AVE, N.W., SUITE C-2, WASHINGTON, DC, 20007, US

(21) Appl. No.: 10/907,820

(22) Filed: Apr. 15, 2005

(51) Int. Cl. G06T 15/00; E04H 3/26

(52) U.S. Cl. 345/419; 52/7

(57) ABSTRACT

Stadium seating arranged within a dome for a virtual reality experience. The stadium seating is arranged in tiers so that the view of the dome, that receives a display or projection, is not obscured from any of the seats. The stadium seating can be brought down to the level or below the level of a floor so that, rather than users using the stadium seating, the users can use the floor and walk around to view the dome.

### FIELD OF THE INVENTION

The present invention is a virtual reality theater. More specifically, the present invention relates to a seating arrangement and screen arrangement to provide an image throughout the user's complete sight line, so that the user does not depart from the virtual reality image being displayed.

### BACKGROUND OF THE INVENTION

The concept of removing oneself from one's normal environment has been around for ages and ages. Whether somebody merely opens the door and goes for a walk, or somebody gets in their car and they take a drive, or they actually go and visit the movie theater and see a movie, a person's goal is to remove their normal surroundings and immerse themselves in an environment that is not commonplace. Even when an individual watches television, the individual focuses on the television screen, so much so that another person in the room might be ignored while that person watches television because the viewer becomes engrossed in the program on the television set.

Clearly, there is a need for individuals to escape their normal reality. Modern technology has gone a long way from merely providing an amphitheater approach to entertainment. If somebody chooses to go to the movie theater these days, not only are the screens larger, but stadium seating has become the rage. With stadium seating, not only are the chairs more comfortable in the movie theater, but the seating of the patrons is tiered, so much so that one patron sitting behind another patron sits so much higher than the patron in front of them that the view of the movie screen is unobscured.

The stadium seating concept, combined with larger-than-ever movie screens, has provided a great escape for an individual from their commonplace activities. Watching a movie is much more than just watching a movie on a large-screen TV, but going to the movie theater actually provides a huge view, so much so that the patron becomes that much more engrossed in the movie being shown.

IMAX theaters have become popular lately, mostly because they provide an enormously sized screen, and depending upon where the patron sits, a large amount of the patrons feel the view is encompassed by the IMAX screen. Thus, the patron not only becomes engrossed in whatever is being shown on the IMAX screen, but the large size of the screen makes the viewer feel as if the viewer is actually part of the scene being shown on the IMAX screen.

For years and years, planetariums have typically had hemispherical projection screens. A planetarium will typically explain where stars are located, constellations are located, and the planetarium will use a hemispherical screen, so that the user feels as if the user is leaning back on the grass during the middle of the night and gazing up at the stars. The hemispherical screen adds to the realism and makes the user feel as if they literally are looking at a sky, because the sky surrounds them, left to right and in every direction.

However, in truth, whether a large screen TV, whether a stadium seating arraignment with a large screen, whether an IMAX screen is used, or even in the case of planetariums, there is still a definite separate between the reality perceived by the patron and the reality that the movie theater desires to provide to the patron. For example, if a viewer is watching television at home, the viewer merely needs to look to the left or the right away from the television screen to depart from whatever is occurring on the television screen. Thus, although watching television is engrossing, the user can simply walk away from the image being portrayed on the television screen, whether intentionally or not, and thus, watching television is far from the best way to shift somebody from their commonplace, day-to-day existence into a virtual reality setting.

Wide-screen TVs, because they are larger and wider, and sometimes have higher definition than a conventional television, are a step farther in bringing the user to a virtual reality existence away from their commonplace environment. However, again, a wide-screen TV, no matter how high its definition and how large it is, can always simply be turned away from, as the user hears a sound and turns to the left or turns to the right, and their eyes gaze away from the screen.

Thus, wide-screen TVs and large-screen TVs are far from the answer to removing somebody from their everyday environment into a virtual reality setting.

Stadium seating, while certainly offering the viewer an unobscured view of the movie screen, can easily, quickly separate the viewer from the image shown on the screen. For example, if the user turns its head to the left, the user will see the wall of the movie theater. If the user looks up, the user will see the ceiling of the movie theater. Thus, while stadium seating is an improvement over the traditional movie theater setting, stadium seating is not an answer to transporting somebody from their everyday environment into another setting.

IMAX movie theaters, with their large screens, provide a very convincing image in such a large sense that the viewer can easily believe that they are flying in an airplane, or falling over a waterfall, for example. Yet again, in an IMAX theater, should the user look up or to the left or to the right, the user will actually see the structure of the IMAX theater, and the user will not be looking at the IMAX screen. And thus, the user again will be pulled out of whatever virtual reality that the IMAX screen has transported them to, and back to the everyday world, an undesirable result.

Even planetariums, with hemispherical screens, take an even greater step toward transporting the viewer to a virtual reality setting. In a planetarium, should the user look to the left or to the right or up, the user will typically see the planetarium's screen. Unfortunately, a planetarium screen is merely a hemisphere. Because a planetarium is only a hemisphere, should the user look beyond its line of sight in the horizontal plane, the user will see the bottom half of the side walls of the planetarium.

As before, this is very undesirable because the user, at one moment, the user could be gazing up above its head and looking at a constellation, or watching a shooting star, and then at the next moment, the user's line of sight might fall to the horizontal plane. And then below the horizontal plane, when the user sees a physical wall because the user's line of sight is below the hemispherical screen in the planetarium, the user is pulled out of its virtual reality.

Thus, there is a need for a device capable of showing a screen image to a user, such that the user's line of sight will find it difficult to escape the screen image being displayed.

Furthermore, there is a need, for cost efficiency, to devise a way that multiple individuals will be able to view such a screen, so that many users can appreciate one viewing on such a screen, but at the same time, the multiple users cannot interfere with the line of sight of the other users.

U.S. Pat. No. 4,885,878, issued on Dec. 12, 1989, to Wuu, shows an advanced state-of-the-art movie theater. Wuu's device has a dome-like spherical configuration that is formed of geodesic triangular panels. The inner wall of Wuu's device functions as a curved motion picture screen surface, and provides an arc 300 degrees around a horizontal plane of the viewer. Further, Wuu's device has a platform supported by hydraulically telescopic legs. The platform is engineered to reproduce sudden thrusts, jerks, vibrations, drops, lifts, tilts and turning actions. Unlike the present invention, Wuu's device has a screen that rises to a height of approximately 10 to 20 feet. Thus, unlike the present invention, Wuu's device is incapable of providing an image throughout the entire line of sight of the viewer.

For example, a viewer using Wuu's device could look up at the ceiling and then, thus, would not be looking at a motion picture image being depicted on the screen. Furthermore, unlike the present invention, Wuu's device does not offer a solution to a viewer's view of a screen being obscured by a viewer sitting immediately in front of that viewer. Furthermore, unlike the present invention, Wuu's device does not offer any means for removing seats if a standing-room-only viewer audience is desired.

Japanese Patent Publication No. 08,068,220A, published on Mar. 12, 1996, invented by Hayashi Masahiko, shows a dome feature. Masahiko's device has a series of galleries that are tiered, such that one gallery would be the first floor; a second gallery would be the second floor; a third gallery would be the third floor. Each of the galleries has a window and that window looks out upon a curved screen, the screen curving from the roof of the structure down to the bottom.

Unlike the present invention, Masahiko's device does not provide for many viewers to view a screen unless it is constructed very, very tall because each viewer has a front-row seat. And so to accommodate many viewers, for example, to accommodate 10 viewers, Masahiko's device would need to be built with enough height to accommodate one viewer stacked atop another viewer, or possible 10 stories high.

Further, unlike the present invention, Masahiko's device forces each viewer to look out a window to see the screen. Should the viewer decide to look up in their gallery or compartment, the user will not see the screen. Should the user choose to look at a 45-degree angle from its horizontal sight line, the viewer will see the point at which the window of its compartment hits the ceiling of its compartment. And again, the user's view of the screen will be obscured.

Thus, unlike the present invention, Masahiko's device does not provide a solution to allowing a virtual reality experience to be consistently enjoyed by a user.

European Patent No. EP-0,688,924B-1, issued to Masahiko Hayashi on Nov. 18, 1998, shows a domed image theater. This European patent is the same invention as in Japanese Publication 08,068,220A, referenced above. This European patent is unlike the present invention for all the reasons mentioned above relating to the Japanese patent. This European patent is offered here merely for the purpose of providing an English-language description of the invention, so that the reader can further appreciate why this European patent, and the aforementioned Japanese patent, are unlike the present invention.

Thus, there is a need for a device that can provide a huge angle of viewing, so much so that the user can turn its head up, down, to the left and to the right, and feel as if they are still part of the motion picture that is being shown on the screen, or any other media that is being shown on the screen.

None of the related art aforementioned provides an adequate solution to this problem. There is a need for a device that is capable of providing images above, below, to the left and to the right of the user, so that the user feels transported to a different place, and can fully be absorbed within the programming shown on the screen.

### SUMMARY OF THE INVENTION

The present invention provides an elliptical or spherical dome surrounding elevated seating, so that the user, sitting in any of the seats in the present invention feels transported to whatever images are being shown on the screen of the present invention. The present invention provides tiered seating, much like that found in a movie theater that has stadium seating.

However, in the present invention, rather than just having tier upon tier of stadium seating, where the highest tier of the stadium seating would terminate at the back wall of the theater, the present invention provides two sections of stadium-tiered seating, such that the back of the highest tier of one section of the stadium seating is back-to-back with the highest tier of a second section of stadium seating.

The screen of the present invention not only is above the head of any of the users sitting in any of the seats of the present invention, but it is also in front of any of the users, as well as to the left and to the right. It also is partially below the users of the present invention, so that when they look down, unless they are looking directly down at the floor, their line of sight will intersect with the screen. Because there is stadium seating, a person directly in front of a user of the present invention will not obscure the view of the user.

Thus, it is fair to say that a user of the present invention has a viewing angle that extends from directly above the user's head down to 45 degrees below the horizontal plane of the user's view. This provides for an all-encompassing display in front of the user, and allows the user to feel as if they have been transported to the scenes being shown on the screen of the present invention.

Because the present invention has two sections of stadium seating, and the two sections of stadium seating are arranged back-to-back, the present invention will show the same image on one-half of its screen that is identical to the image that is shown on the other half of the screen.

For example, a user will only see one solid image because the user in one section of the stadium seating will have its back to the second image of the present invention, and the user in the second section of the stadium seating will have its back to the first image shown in the present invention.

Further, the present invention provides for the back-to-back stadium seating to be retracted into the floor of the present invention. The retraction into the floor is important, so that a flat floor can be provided for weddings, dance parties, concert venues, etc., so that weddings, dance parties, concert venues, and any other event can be held within the dome of the present invention without the stadium seating obscuring mobility. When the stadium seating of the present invention is retracted into the floor of the present invention, the user will have a flat floor within the present invention to walk on, to dance on, or to perform any other activity on.

It is contemplated that rather than have two identical images being shown as when the stadium seating is employed in the present invention, when the stadium seating is actually retracted into the floor, one consistent image will be shown on the screen of the present invention because the user will be able to turn left, turn right, turn around in one solid, fluid image, so that the user feels as if they are in a garden or on a cliff near a beach or walking in outer space, will be shown.

### BRIEF DESCRIPTION OF THE DRAWINGS

FIG. 1 is a cross section view of the seating of the present invention.

FIG. 2 is an environmental view of the seating of the present invention.

FIG. 3 is an environmental view of the seating moving into the floor of the present invention.

FIG. 4 is a cross section view of the seating moved into the floor of the present invention.

### DETAILED DESCRIPTION

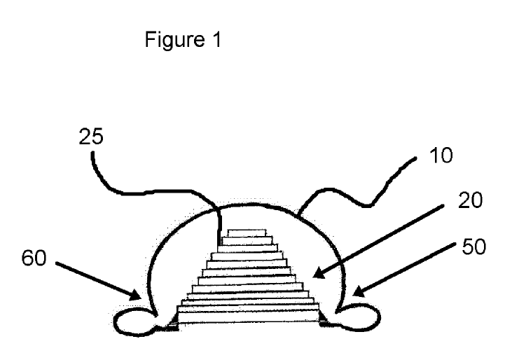

FIG. 1 shows a cross section of the present invention so that the general design of the present invention can be appreciated. There are two main elements of the present invention, and they are the dome (10) and the seating (20), the seating (20) being elevated as shown in FIG. 1. It is important to understand that FIG. 1 shows the general structure of the present invention when users will be seated. The seating (20) is positioned within dome (10) so that the interior surface of dome (10) is visible from elevated seating (20).

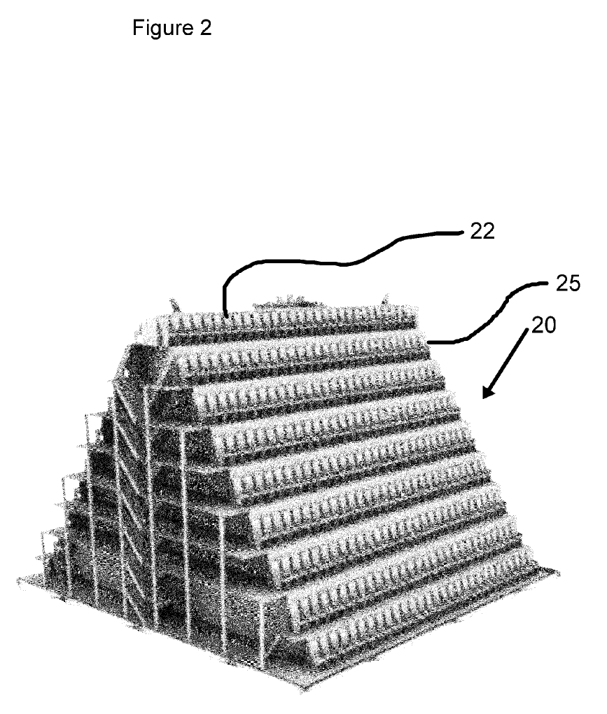

As shown in FIG. 2, seating (20) is essentially rows of seats (22) arranged in tiers (25) much like conventional stadium seating in current movie theaters. Seating (20) is preferably 90 square feet because as such, seating (20) can conventionally accommodate 500 users. Seating (20) is arranged so that seats (22) are back to back on the same tier (25), or in other words, so that a user would sit with its back toward the back of another user on the same tier (25). Access to seats (22) is conventional, with conventional stairways, hallways, corridors, etc.

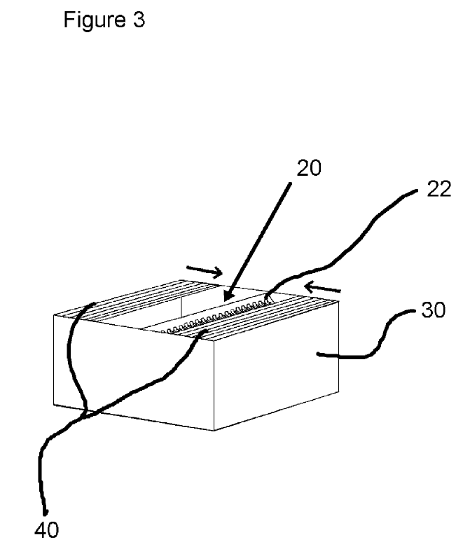

Seating (20) can be moved from its elevated position to a retracted position in lower portion (30) as shown in FIG. 3 via any conventional hydraulic system. In this embodiment of the present invention, seating (20) moves as one entire piece into a retracted position. When in its retracted position, seating (20) has all tiers (25) below a floor covering (40). In the preferred embodiment, floor covering (40) is conventionally sliding pieces of floor that completely cover seating (20) so that the present invention can be used as a dance floor, convention area, or for any other setting that requires a floor without tiers (25).

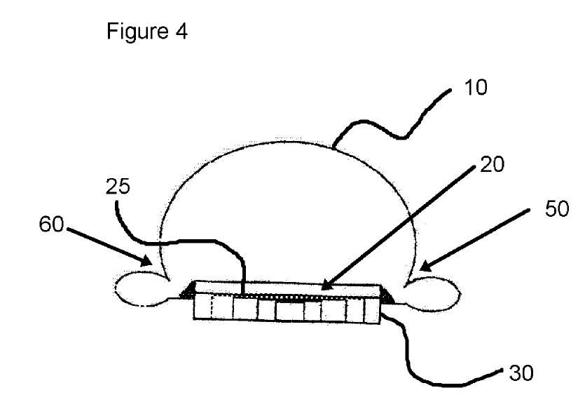

An alternative embodiment of the present invention also has seating (20) moved from its elevated position to a retracted position in lower portion (30) as shown in FIG. 4. However, in comparison to the embodiment shown in FIG. 3, the alternative embodiment in FIG. 4 has each tier (25) moving independently of other tiers (25) into lower portion (30) via conventional hydraulics. This embodiment, although more complicated in terms of hydraulics because each tier (25) moves into lower portion (30) separate from other tiers (25), would allow lower portion (30) to be more shallow than if the one entire piece of seating (20) moves as in FIG. 3. As in FIG. 3, floor covering (40) can then be deployed via any conventional means to provide a flat surface floor above retracted seating (20).

As shown in FIGS. 1 and 4, dome (10) of the present invention not only is above the head of any of the users sitting in any of the seats (22) or standing on floor covering (40), but dome (10) is also in front of any of the users, as well as to the left and to the right. In other words, FIGS. 1 and 4 are a cross section made vertically along any diameter of the present invention for purposes of showing the relationship between dome (10) and seating (20) and floor covering (40). Dome (10) is partially below the users of the present invention as well, as evidenced by first portion (50) and second portion (60) that extend below the lowest tier (70) of tiers (25) of seating (20). Similarly, first portion (50) and second portion (60) extend below the floor covering (40). First portion (50) and second portion (60) are important to the present invention, as because of them, when a user looks down, unless the user is looking nearly directly down below, the user's line of sight will intersect with the dome (10). The tiers (25) prevent a first user sitting directly in front of a second user from obscuring the view of the second user, as each tier (25) is elevated as is conventional stadium seating.

Projection or display of an image for users is fundamental to the present invention, and such can be accomplished via any conventional means so that dome (10) is the surface for displaying the projection or display. It is contemplated that projection or display of an image for users could even be accomplished via conventional means such as rear projection behind dome (10) or from projectors mounted on each of seats (22).

The present invention is not limited in scope to the embodiments described above, but encompasses any and all embodiments within the scope of the following claims.

What is claimed is:

1. A virtual reality theater, comprising:
seats, tiered in a stadium style; and
a dome, extending above, below, and laterally of said
seats.

2. The invention of claim 1, wherein said seats are arranged back to back.

3. The invention of claim 1, further comprising a floor that receives said seats.

4. The invention of claim 3, wherein said floor opens to receive said seats.

5. The invention of claim 3, wherein said floor closes to provide one continuous flat surface.

6. The invention of claim 3, wherein said seats move as one into said floor.

7. The invention of claim 1, wherein each tier of said seats is individually supported above a floor.

8. The invention of claim 7, wherein each tier of said seats moves into and below said floor.

9. The invention of claim 1, wherein said dome displays at least one image.

10. A virtual reality theater, comprising:
a floor; and
a dome, extending above, below, and laterally of
said floor.

11. The invention of claim 10, wherein said dome displays at least one image.
